(19) United States
(12) Patent Application Publication
(10) Pub. No.: US 2017/0265407 A1
(43) Pub. Date: Sep. 21, 2017

(54) Wicking and Hydration Systems for Potted Plants and Flowers

(71) Applicant: Rocket Farms, Inc., Salinas, CA (US)

(72) Inventor: Marc Jason Kamimoto, Salinas, CA (US)

(73) Assignee: Rocket Farms, Inc., Salinas, CA (US)

(21) Appl. No.: 15/073,915

(22) Filed: Mar. 18, 2016

(51) Int. Cl. A01G 27/06; A01G 1/00; A01G 27/00

(52) U.S. Cl. CPC A01G 27/06; A01G 27/008; A01G 1/001

(57) ABSTRACT

A self-watering system for a potted plant or potted flower is disclosed that includes an outer pot, comprising an inside surface, and outer surface, and a riser, platform or raised surface having a tailored height and coupled with the inside surface of the outer pot; a reservoir, wherein the reservoir is bounded by the inside surface of the outer pot and the riser, platform or raised surface; and a wick having a first end and a second end, wherein the first end is designed to be inserted into the bottom of an inner pot and the second end is designed to rest in the reservoir. A method of using a self-watering system is also disclosed. Wicking and hydration system for organic or conventionally grown plants and flowers has been developed and is described herein that is: a) adjustable to the particular plant or flower, b) reusable, and in some instances may be recyclable or biodegradable, thus reducing waste, c) relatively simple to use and clean.

### FIELD OF THE SUBJECT MATTER

The field of the subject matter is a wicking and hydration systems for plants, flowers and other organic or conventionally grown matter that needs or would perform better with proper hydration.

### BACKGROUND

There are a number of watering systems that have been developed to keep plants and flowers fresh and alive until they are transported, sold, used and/or transplanted. For cut flowers, companies make plastic containers that hold the cut end of the freshly cut flower or plant, along with a couple of tablespoons of water, so that the cut flowers can be transported and remain hydrated. These flowers are usually given as gifts or used for events, such as the Rose Bowl parade.

Other conventional watering systems have been developed to provide and maintain hydration to potted plants and flowers. US Patent Publication 2014/0130412 discloses an outer pot having an inner cavity for receiving an inner pot, the outer pot having an interior where a tray structure is provided comprising trays dividing said interior into sub-chambers arranged at different levels for supplying watering liquid towards the inner cavity at different heights through openings formed in the outer and inner pots. Valve means operated according to the hydrostatic pressure of the watering liquid in the sub-chamber are provided for allowing controlled supply of watering liquid to the inner cavity. Adjusting means are provided for controlling the amount of watering liquid supplied into each sub-chamber. While this system is likely reusable, there are a considerable number of crevices and holes that need to be cleaned to be reused, and given that there's water present in the system, there is more surface area for mold to develop, especially in warm, humid areas.

Another watering system disclosed in US Patent Publication 2012/0198767 suffers from the same problems as the publication described above, in that it discloses a wick system, but there are a number of crevices and holes that will need to be cleaned to be reused, and again, given that there's water present in the system, there is more surface area for mold to develop, especially in warm, humid areas.

In another example, US Patent Publication 2014/0007501 discloses a self-watering plant system that includes a refillable reservoir configured to store a liquid; at least one interchangeable wick: a wick holder configured to hold circumferentially the at least one interchangeable wick; and a wick housing configured to house the at least one interchangeable wick and securely couple with the wick holder. This system is a bit complicated, in that it has adjustment knobs and wick housings. Therefore, it may not be a cost effective system.

To this end, it would be desirable to develop a wicking and hydration system for organic and/or conventionally grown plants and flowers that is a) adjustable to the particular plant or flower, b) is reusable, and in some instances may be biodegradable or recyclable, thus reducing waste, c) is relatively simple to use and clean.

### SUMMARY OF THE SUBJECT MATTER

A self-watering system for a potted plant or potted flower is disclosed that includes an outer pot, comprising an inside surface, and outer surface, and a riser, platform or raised surface having a tailored height and coupled with the inside surface of the outer pot; a reservoir, wherein the reservoir is bounded by the inside surface of the outer pot and the riser, platform or raised surface; and a wick having a first end and a second end, wherein the first end is designed to be inserted into the bottom of an inner pot and the second end is designed to rest in the reservoir.

Methods of using a self-watering system for a potted plant or potted flower include: providing an outer pot, comprising an inside surface, and outer surface, and a riser, platform or raised surface having a tailored height and coupled with the inside surface of the outer pot; providing a reservoir, wherein the reservoir is bounded by the inside surface of the outer pot and the riser, platform or raised surface; providing a wick having a first end and a second end, wherein the first end is designed to be inserted into the bottom of an inner pot and the second end is designed to rest in the reservoir; providing an inner pot, wherein the inner pot holds a potted plant, a potted flower or a combination thereof; inserting the first end of the wick into the bottom of the inner pot, adding water to the reservoir, placing the inner pot on the riser, platform or raised surface; and resting the second end of the wick into the water-filled reservoir.

### BRIEF DESCRIPTION OF THE FIGURES

FIG. 1 shows a contemplated embodiment.

FIG. 2A shows a portion of a contemplated method.

FIG. 2B shows a portion of a contemplated method.

FIG. 2C shows a portion of a contemplated method.

FIG. 2D shows a portion of a contemplated method.

FIG. 3 shows a contemplated method.

### DETAILED DESCRIPTION

A wicking and hydration system for organic or conventionally grown plants and flowers has been developed and is described herein that is: a) adjustable to the particular plant or flower, b) reusable, and in some instances may be recyclable or biodegradable, thus reducing waste, c) relatively simple to use and clean.

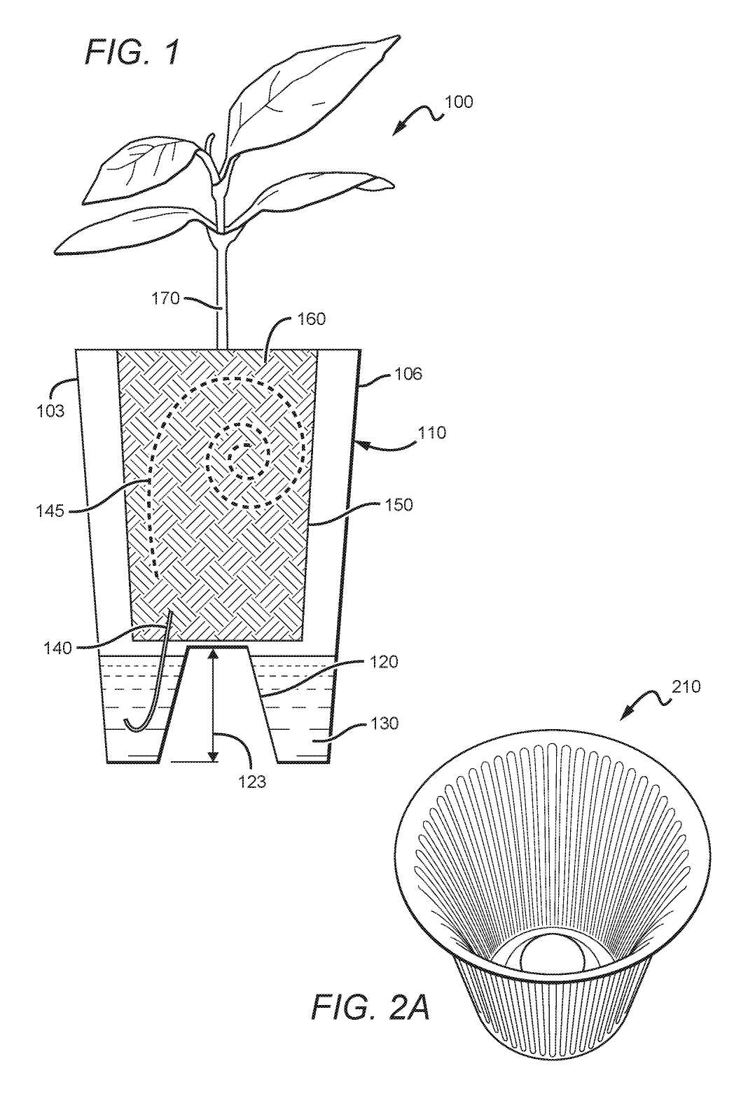

A self-watering system 100 for a potted plant or potted flower is disclosed and is shown in FIG. 1 that includes an outer pot 110, comprising an inside surface 103, and outer surface 106, and a riser, platform or raised surface 120 having a tailored height 123 and coupled with the inside surface of the outer pot; a reservoir 130, wherein the reservoir is bounded by the inside surface of the outer pot and the riser, platform or raised surface; and a wick 140 having a first end and a second end, wherein the first end is designed to be inserted into the bottom of an inner pot 150 and the second end is designed to rest in the reservoir. As will be described herein, the wick 140 is designed to draw 145 water and/or liquid from the reservoir 130 into the soil 160 in the inner pot 150, so that the water and/or liquid and hydrate a seedling, seed or plant 170.

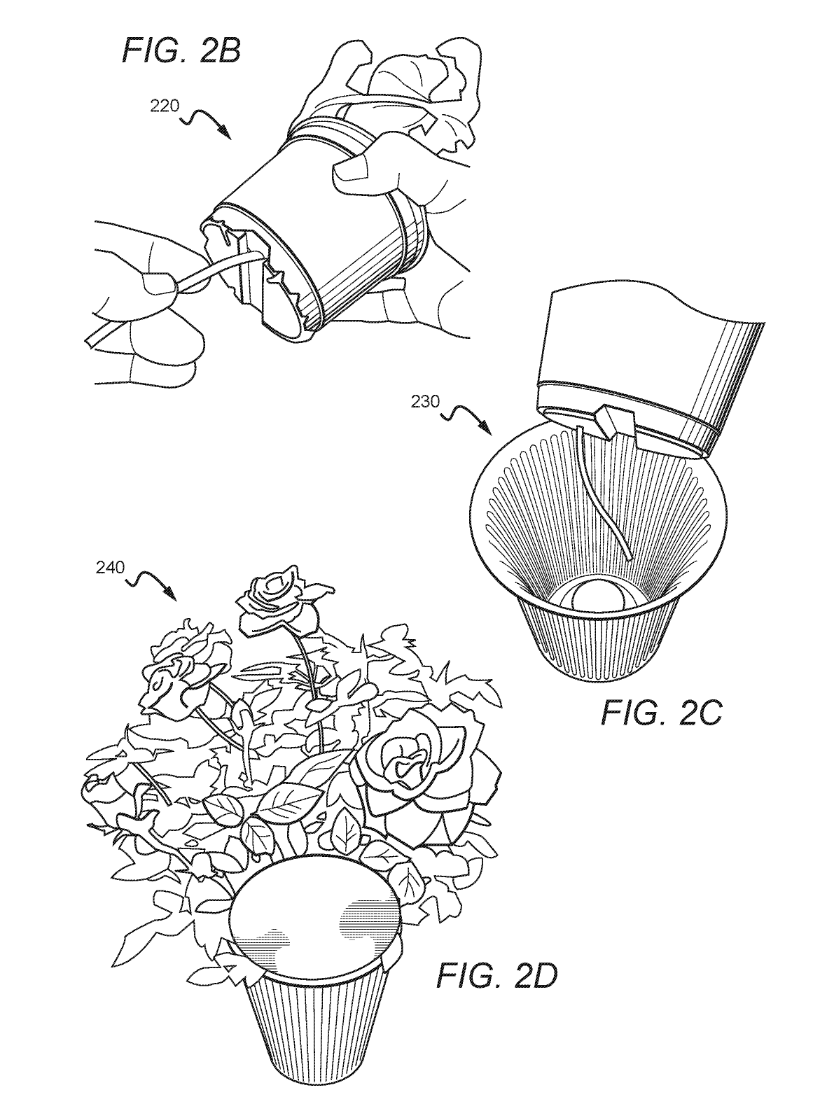

As disclosed herein, a contemplated outer pot 210, shown in FIG. 2A, is designed to be the first part of the two-part wicking and hydration system. Contemplated outer pots comprise an inside surface that is essentially the inside of the outer pot, and outer pots also comprise an outer surface, which is the outside of the pot. Inside the outer pot, a riser, platform or raised surface is coupled to the inside surface. The inside surface of the outer pot and the riser, platform or raised surface work together to form and bound a reservoir.

A contemplated reservoir is designed to hold a prescribed or tailored amount of water to keep a particular plant hydrated for a fixed period of time. These contemplated reservoirs are improvements over conventional water reservoirs, in that they are bounded, enclosed such that they don't allow water to slosh out or spill when the pot system is moved, and simply-designed.

A contemplated riser, platform or raised surface is relatively or substantially flat, such that an inner pot that holds a live plant, a flowering plant, a root system, soil, fertilizer or a combination thereof can rest on the riser, platform or raised surface without the need to be secured. It should be understood that a contemplated riser, platform or raised surface has a sufficient enough surface area, so that the inner pot can rest securely on the riser, platform or raised surface without tipping over to one side.

One advantage to contemplated systems is that the riser, platform or raised surface can be at a tailored height in order to provide a larger or smaller reservoir. For some plants, a significant amount of water isn't necessary to keep the plant hydrated and healthy during storage or transport, while other plants or flowers need a significant amount of water during a week or two. Therefore, outer pots and riser, platform or raised surface systems can be tailored to allow for 1-2 cups of water in the reservoir or only a quarter or half cup of water.

Contemplated wicks may comprise any suitable material that allows a fluid, such as water or a suitable liquid or liquids, to travel or be drawn from the reservoir and into the materials located inside the inner pot. Contemplated wicks may be biodegradable, in that they are designed to break down or decompose naturally over time into materials that are considered safe for the environment.

Contemplated outer pots, contemplated inner pots or a combination thereof may also be recyclable and/or biodegradable, in that they are designed to break down or decompose naturally over time into materials that are considered safe for the environment. In the instances where the outer pots are recyclable, they may be made out of any type of material that would allow for recycling, including plastic.

In some embodiments, a wicking and hydration system may be designed such that the outer pot, the inner pot and the wick are biodegradable. This would allow a plant to be transported from a distance or stored for a period of time, while remaining hydrated, and then would further allow the wicking and hydration system to be planted in the ground with the plant or flowering plant, such that the user has no waste or trash.

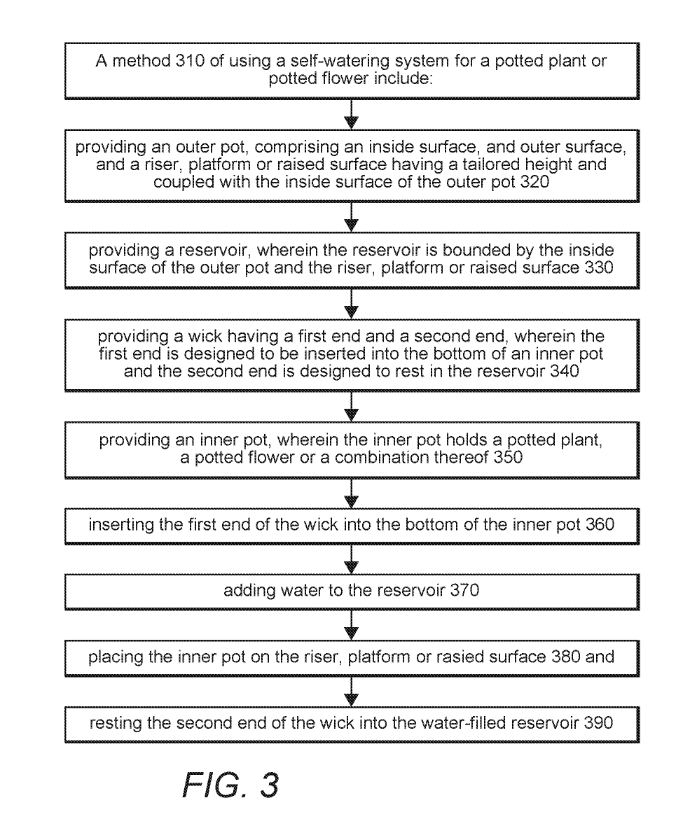

Methods 310, as shown in FIG. 3, of using a self-watering system for a potted plant or potted flower 240, as shown in FIG. 2D, include: providing 320 an outer pot, comprising an inside surface, and outer surface, and a riser, platform or raised surface having a tailored height and coupled with the inside surface of the outer pot; providing 330 a reservoir, wherein the reservoir is bounded by the inside surface of the outer pot and the riser, platform or raised surface; providing a wick 340 having a first end and a second end, wherein the first end is designed to be inserted into the bottom of an inner pot and the second end is designed to rest in the reservoir; providing 350 an inner pot, wherein the inner pot holds a potted plant, a potted flower or a combination thereof; inserting 220 and 360 the first end of the wick into the bottom of the inner pot, as shown in FIG. 2B, adding water 370 to the reservoir, placing 230 and 380 the inner pot on the riser, platform or raised surface, as shown in FIG. 2C; and resting 390 the second end of the wick into the water-filled reservoir.

Thus, specific embodiments, methods of wicking and hydration systems for organic and/or conventionally grown plants and flowers have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the specification and claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. A self-watering system for a potted plant or potted flower, the system comprising:
an outer pot, comprising an inside surface, and outer surface, and a riser, platform or raised surface having a tailored height and coupled with the inside surface of the outer pot;
a reservoir, wherein the reservoir is bounded by the inside surface of the outer pot and the riser, platform or raised surface; and
a wick having a first end and a second end, wherein the first end is designed to be inserted into the bottom of an inner pot and the second end is designed to rest in the reservoir.

2. The self-watering system of claim 1, wherein the inner pot contains a live plant, a flowering plant, a root system, soil, fertilizer or a combination thereof.

3. The self-watering system of claim 1, wherein the inner pot consists essentially of a live plant, a root system, soil and fertilizer.

4. The self-watering system of claim 1, wherein the inner pot consists essentially of a flowering plant, a root system, soil and fertilizer.

5. The self-watering system of claim 1, wherein the tailored height is specific to the type of potted plant or potted flower.

6. The self-watering system of claim 1, wherein the riser, platform or raised surface comprises a top that is substantially flat.

7. The self-watering system of claim 1, wherein the potted plant or potted flower sits on the riser, the platform or the raised surface.

8. A method of using a self-watering system for a potted plant or potted flower, the method comprising:
providing an outer pot, comprising an inside surface, and outer surface, and a riser, platform or raised surface having a tailored height and coupled with the inside surface of the outer pot;
providing a reservoir, wherein the reservoir is bounded by the inside surface of the outer pot and the riser, platform or raised surface;
providing a wick having a first end and a second end, wherein the first end is designed to be inserted into the bottom of an inner pot and the second end is designed to rest in the reservoir;
providing an inner pot, wherein the inner pot holds a potted plant, a potted flower or a combination thereof;
inserting the first end of the wick into the bottom of the inner pot, adding water to the reservoir,
placing the inner pot on the riser, platform or raised surface; and
resting the second end of the wick into the water-filled reservoir.

9. The method of claim 8, wherein the inner pot contains a live plant, a flowering plant, a root system, soil, fertilizer or a combination thereof.

10. The method of claim 8, wherein the inner pot consists essentially of a live plant, a root system, soil and fertilizer.

11. The method of claim 8, wherein the inner pot consists essentially of a flowering plant, a root system, soil and fertilizer.

12. The method of claim 8, wherein the tailored height is specific to the type of potted plant or potted flower.

13. The method of claim 8, wherein the riser, platform or raised surface comprises a top that is substantially flat.
